(19) United States
(12) Patent Application Publication
(10) Pub. No.: US 2009/0197492 A1
(43) Pub. Date: Aug. 6, 2009

(54) TEXTILE PRODUCT WITH FLAME RETARDED BACK-COATING AND METHOD OF MAKING THE SAME

(75) Inventors: Manon Loos, Corbais (BE); Danielle F. Goossens, Nodebais (BE)

Correspondence Address: ALBEMARLE CORPORATION;PATENT DEPARTMENT, 451 FLORIDA STREET, BATON ROUGE, LA, 70801, US

(73) Assignee: Albemarle Europe SPRL, Louvain-la-Neuve (BE)

(21) Appl. No.: 12/304,580

(22) PCT Filed: Jul. 5, 2007
(86) PCT No.: PCT/IB2007/004430

§ 371 Date: Dec. 12, 2008

Related U.S. Application Data
(60) Provisional application No. 60/818,556, filed on Jul. 5, 2006.

(51) Int. Cl. B32B 27/04; C09K 21/14

(52) U.S. Cl. 442/146; 442/147; 252/608

(57) ABSTRACT

Textile products having a flame retarded coating wherein the flame retarded coating contains as a flame-retarding agent a composition comprising N-2,3-Dibromopropyl-4,5-dibromohexahydrophthalimide.

### SUMMARY OF THE INVENTION

The present invention relates to a textile product having a flame retarded coating. More particularly, the present invention relates to a textile product having a flame retarded coating wherein the flame retarded back-coating contains as a flame-retarding agent a composition comprising N-2,3-Dibromopropyl-4,5-dibromohexahydrophthalimide.

### BACKGROUND OF THE INVENTION

Generally, commercial textile products are required by law to have flame retardant properties in order to help prevent flame spread in the event of a fire. Therefore, in many applications, commercial textile products consist of at least two distinct components, a textile material and a back-coating material. The back-coating material, sometimes referred to as a backing layer or blocking sheet, is used to impart flame retardant properties to a given textile product. For instance, transportation upholstery material is used in conjunction with separate fire blocking sheet layers. As a further example, many carpets include secondary or tertiary backing layers that have flame retardant properties.

In order to provide for such flame-retarded textiles, it has been proposed to use a variety of materials to provide the backing material or blocking sheet with flame retardant properties. For example, U.S. Pat. No. 7,011,724 teaches that intumescent particles can be used in the back-coating of carpet to provide the carpet with flame-retardant properties.

In other prior art teachings, specific brominated or phosphorous-based flame retardants are described as being useful towards providing blends of cotton and polyester fibers with flame retardant properties. For example, see U.S. Pat. Nos. 3,997,699 and 4,167,603.

In other teachings, the textile product itself is comprised of fibers having flame retardant or smoke suppressant properties, for example see U.S. Pat. No. 4,012,546.

However, even with these teachings, the textile industry's demand for flame retardant products is increasing. Thus, there is constantly a need in the art for flame retarded textiles.

### SUMMARY OF THE INVENTION

The present invention relates to a textile product having affixed thereto a flame retarding amount of a N-2,3-Dibromopropyl-4,5-dibromohexahydrophthalimide.

In another embodiment, the present invention relates to a textile product having a coating layer deposited thereon, said coating layer containing a flame retarding amount of N-2,3-Dibromopropyl-4,5-dibromohexahydrophthalimide.

In yet another embodiment, the present invention relates to a textile product having a back-coating containing a flame retarding amount of N-2,3-Dibromopropyl-4,5-dibromohexahydrophthalimide.

In yet another embodiment, the present invention relates to a textile product having reduced flame spread characteristics comprising a textile material and a coating applied to a surface of said textile material and forming a layer thereon, said coating comprising a flame retarding amount of N-2,3-Dibromopropyl-4,5-dibromohexahydrophthalimide.

In still yet another embodiment, the present invention relates to a method of imparting flame retardancy to a textile comprising affixing to said textile a coating comprising a flame retarding amount of N-2,3-Dibromopropyl-4,5-dibromohexahydrophthalimide.

### DETAILED DESCRIPTION OF THE INVENTION

Textile, as used herein, is used in its broadest sense and is meant to refer to any fabric, filament, staple, or yarn, or products made therefrom, which may be woven or non-woven and all fabrics, cloths, carpets, etc. made from synthetic and/or natural fibers especially polyamides, acrylics, polyesters, and blends thereof, cellulosic textile material, including cotton, corduroy, velvet brocade, polyester-cotton blends, viscose rayon, jute, and products made from wood pulp. Non-limiting examples of textiles suitable for use in the present invention thus include natural and/or synthetic carpets; fabrics and/or cloths made from synthetic fibers such as polyesters, polyamides, nylons, acrylics, etc.; fabrics and/or cloths made from natural fibers such as cotton; and fabrics and/or cloths made from blends of synthetic fibers and natural fibers such as cotton/polyester blends. It should be noted that it is also within the scope of the present invention that, in some embodiments, the natural and/or synthetic fibers that make up the textiles of the present invention also be flame retarded. Such flame-retarded fibers are well known in the art, and the selection of such a fiber is readily achievable by one having ordinary skill in the art.

The textiles of the present invention have affixed thereto a flame retarding amount of a N-2,3-Dibromopropyl-4,5-dibromohexahydrophthalimide, which has the formula:

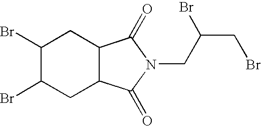

When used herein, N-2,3-Dibromopropyl-4,5-dibromohexahydrophthalimide is meant to encompass the tautomeric forms, stereo isomers, and polymorphs of the above formula also.

By a flame retarding amount of a N-2,3-Dibromopropyl-4,5-dibromohexahydrophthalimide, it is meant that the textile comprises in the range of from about 5 to about 60 wt. % N-2,3-Dibromopropyl-4,5-dibromohexahydrophthalimide, based on the total weight of the textile. In preferred embodiments, the textile comprises in the range of from about 15 to about 40 wt. %, more preferably in the range of from about 25 to about 30 wt. %, N-2,3-Dibromopropyl-4,5-dibromohexahydrophthalimide, on the same basis.

The method by which the N-2,3-Dibromopropyl-4,5-dibromohexahydrophthalimide is applied to the textile is not critical to the instant invention and can be selected from any method known in the art that is effective at applying a flame-retarding agent to a textile. For instance, the N-2,3-Dibromopropyl-4,5-dibromohexahydrophthalimide can be dispersed and/or applied to the textile by methods such as spraying, dipping, soaking etc.

However, in a preferred embodiment, the N-2,3-Dibromopropyl-4,5-dibromohexahydrophthalimide is contained in a layer such as a backing, back layer, or back-coating, referred to collectively herein as back-coating, that is applied to a surface of the textile. The back-coating is typically derived from a polymer compound and a suitable liquid carrier material in which the N-2,3-Dibromopropyl-4,5-dibromohexahydrophthalimide is dispersed. The liquid carrier material can be any suitable liquid carrier material commonly used in producing back-coatings such as organic liquids and water. In preferred embodiments, the liquid carrier material is water.

The selection of the polymer used in the back-coating is readily achievable by one having ordinary skill in the art. Typically the polymer of the back-coating can be selected from any of a large number of stable polymeric dispersions known and used for binding, coating, impregnating or related uses, and may be of a self crosslinking type or externally crosslinked type. The polymeric constitutent can be an addition polymer, a condensation polymer or a cellulose derivative. Non-limiting examples of suitable polymers include foamed or unfoamed organosols, plastisols, latices, and the like, which contain one or more polymeric constituents of types which include vinyl halides such as polyvinyl chloride, polyvinyl chloride-polyvinyl acetate and polyethylene-polyvinyl chloride; polymers and copolymers of vinyl esters such as polyvinyl acetate, polyethylene-polyvinyl and polyacrylic-polyvinyl acetate; polymers and copolymers of acrylate monomers such as ethyl acrylate, methyl acrylate, butyl acrylate, ethylbutyl acrylate, ethylhexyl acrylate, hydroxyethyl acrylate and dimethylaminoethyl acrylate; polymers and copolymers of methacrylate monomers such as methyl methacrylate, ethyl methacrylate, isopropyl methacrylate and butyl methacrylate; polymers and copolymers of acrylonitrile, methacrylonitrile, acrylamide, N-iso-propylacrylamide, N-methylolacrylamide and methacrylamide; vinylidene polymers and copolymers such as polyvinylidene chloride, polyvinylidene chloride-polyvinyl chloride, polyvinylidene chloride-polyethyl acrylate and polyvinylidene chloride-polyvinyl chloride-polyacrylonitrile; polymers and copolymers of olefin monomers including ethylene and propylene as well as polymers and copolymers of 1,2-butadiene, 1,3-butadiene, 2-ethyl-1,3-butadiene, and the like; natural latex; polyurethanes, polyamides; polyesters; polymers and copolymers of styrene including styrene, 2-methylstyrene, 3-methylstyrene, 4-methylstyrene, 4-ethylstyrene, and 4-butylstyrene; phenolic emulsions; aminoplast resins and the like. The use of such polymers in back-coating textiles is well-known in the art, for example, see U.S. Pat. Nos. 4,737,386 and 4,304,812.

In preferred embodiments, the polymer of the back-coating is either a polymer latex or a polymer plastisol compound, more preferably a polymer latex. In some embodiments, the latex polymer used for the back-coating includes a polyvinylidene chloride copolymer with at least one acrylic monomer. Standard acrylic monomers include, for example, acrylic acid, methacrylic acid, esters of these acids, or acrylonitrile, ethyl acrylate, butylacrylate, glycidyl methacrylate, N-methylolacrylamide, acrylonitrile, 2-hydroxyethyl acrylate, ethylene dimethacrylate, vinyl acetate, butyl acetate, and the like. Alternatively, the backcoating may comprise conventional thermoplastic polymers, which can be applied to the textile by hot melt techniques known in the art.

The back-coating can optionally include additional components, such as other fire retardants, dyes, wrinkle resist agents, foaming agents, buffers, pH stabilizers, fixing agents, stain repellants such as fluorocarbons, stain blocking agents, soil repellants, wetting agents, softeners, water repellants, stain release agents, optical brighteners, emulsifiers, thickeners, and surfactants.

The back-coating is typically formed by combining the polymer, liquid carrier material, optional components, and N-2,3-Dibromopropyl-4,5-dibromohexahydrophthalimide in any manner and order known, and the method and order is not critical to the instant invention. For example, these components, both optional and otherwise, could be mixed together in a storage vessel, etc.

Further, the back-coating can be applied to the surface of the textile through any means known in the art. For example, the use of coating machines such as those utilizing pressure rolls and chill rolls can be used, “knife” coating methods, by extrusion, coating methods, transfer methods, coating, spraying, foaming or the like. The amount of back-coating applied to the textile is generally that amount sufficient to provide for a textile having a flame retarding amount of a N-2,3-Dibromopropyl-4,5-dibromohexahydrophthalimide, as described above. After application of the back-coating, the back-coating can be cured on the textile by heating or drying or in any way reacting the back-coating.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. The following examples will illustrate the present invention, but are not meant to be limiting in any manner.

### EXAMPLES

In the following examples, the effectiveness of a back-coating containing N-2,3-Dibromopropyl-4,5-dibromohexahydrophthalimide as a flame retardant for polyester/acrylic fabric is described.

First, a N-2,3-Dibromopropyl-4,5-dibromohexahydrophthalimide dispersion was prepared, which was subsequently used to prepare a back-coating that was applied to the polyester/acrylic fabric.

The flame retardant efficacy of the N-2,3-Dibromopropyl-4,5-dibromohexahydrophthalimide-containing back-coating was measured with the British Standard 5852 before and after water soaking (British Standard 5651).

These examples demonstrate that N-2,3-Dibromopropyl-4,5-dibromohexahydrophthalimide-containing back-coatings can be prepared and applied to fabrics without problems, and these back-coated fabrics pass the BS5852 test at an add-on level of 42.8%. Further, these back-coated fabrics do not lose any weight and pass the BS5852 test after the water soaking test (British Standard 5651), which make N-2,3-Dibromopropyl-4,5-dibromohexahydrophthalimide-containing back-coatings suitable for use in upholstered furniture applications.

### Example

### 1. Preparation of the N-2,3-dibromopropyl-4,5-dibromohexahydrophthalimide Dispersion

In order to form a N-2,3-Dibromopropyl-4,5-dibromohexahydrophthalimide dispersion, 145.2 g water was placed in a plastic vessel equipped with a four-leaf stirrer. Under constant stirring, 2.15 g of Suparex K, a dispersant commercially available from Clariant, was added to the water. After the complete mixing of the water and Suparex K, 2.95 g of Alcopol OPG, a wetting agent commercially available from Ciba Specialty Chemicals, was then added to the mixture in the cup along with 345.1 g of N-2,3-Dibromopropyl-4,5-dibromohexahydrophthalimide. After the addition of all of the components, the speed of the stirrer was increased to 1500 rpm, and the contents of the vessel were mixed for 2-3 minutes.

4.6 g of Texigel®, a polyacrylate thickener available commercially from Scott Bader Ltd., were then added to the contents of the vessel under constant mixing. The viscosity of the dispersion should be in the range of from about 2000 to about 6000 cP, and the dispersion should have a pH in the range of from about 7.5 to about 9.5. If the viscosity is too low, the amount of Texigel® can be increased, if the viscosity is too high, water can be added. The viscosity was easily measured with a Brookfield (DV-E) viscometer. If the pH is too low, ammonia can be added while if it is too high Performax® 111115, commercially available form Noveon Performance Coatings, can be added. The pH was measured with a Metrohm (691) pH meter.

The amount of each component in the dispersion is contained in Table 1 below. It should be noted that FR is used synonymously with the N-2,3-Dibromopropyl-4,5-dibromohexahydrophthalimide flame retardant. Also, wet wt. % is based on the total weight of the dispersion.

TABLE 1
Formulation for the FR dispersion

| | TSC | Dry pphr | | |
|---|---|---|---|---|
| | (Total Solid | (parts per | Wet | Wet |
| Material | Content) | hundred FR) | pphr | wt. % |
| Water | 0 | — | 42.7 | 29.04 |
| Suparex K (dispersant) | 100 | 0.62 | 0.62 | 0.43 |
| Alcopol (wetting agent) | 70 | 0.6 | 0.86 | 0.59 |
| FR | 100 | 100 | 100 | 69.02 |
| Texigel ® (thickener) | 15 | 0.2 | 1.33 | 0.92 |
| TOTAL | 70 | 101.42 | 144.88 | 100 |

### 2. Preparation of the Back-Coating

In order to form the N-2,3-Dibromopropyl-4,5-dibromohexahydrophthalimide-containing back-coating, 129.8 g Vycar 460×46, a PVC emulsion binder commercially available from Noveon Performance Coatings, was introduced into a plastic vessel plastic vessel equipped with a four-leaf stirrer and gently stirred. To the plastic vessel under content stirring, 19.1 g of Santicizer® 141, a plasticizer commercially from Ferro Corporation, were added followed by 0.7 g of Suparex DE 104, an antifoaming agent available commercially from Clariant. After 2 minutes of stirring, 25.45 g of Viscalex® HV30, an acrylic thickener commercially available from Ciba Specialty Chemicals, were added along with 93.35 g of water followed by 4.45 g of ammonia (25%). After 5 minutes of constant stirring, 227 g of the N-2,3-Dibromopropyl-4,5-dibromohexahydrophthalimide dispersion described in Table 1 were added. The speed of the stirrer was increased to 1500-2000 rpm, and the pH and viscosity of the contents of the plastic vessel were measured. The viscosity should be in the range of from about 7000 and 9000 cP. If the viscosity is too low, the amount of Viscalex® HV30 can be increased, if the viscosity is too high, Performax® 11115 can be added. The pH should be in the range of from about 9.2 to about 10. If the pH is too low ammonia can be added while if it is too high Performax® 11115, commercially available form Noveon Performance Coatings can be added.

The amount of each component in the back-coating is contained in Table 2 below. It should be noted that FR is used synonymously with the N-2,3-Dibromopropyl-4,5-dibromohexahydrophthalimide flame retardant. Also, wet wt. % is based on the total weight of the back-coating.

TABLE 2
Formulation for the Back-coating

| Material | TSC | Dry pphr | Wet pphr | Wet wt. % |
|---|---|---|---|---|
| Vycar (VC acrylate) | 49 | 100 | 204.08 | 25.96 |
| Santicizer 141 (plasticizer) | 100 | 30 | 30 | 3.82 |
| Suparex DE104 (antifoam) | 100 | 1.08 | 1.08 | 0.14 |
| Viscalex HV30 (thickener) | 30 | 12 | 40 | 5.09 |
| Water | 0 | — | 146.86 | 18.67 |
| Ammonia | 0 | — | 7 | 0.89 |
| FR dispersion | 70 | 250 | 357.14 | 45.43 |
| TOTAL | 50 | 393.08 | 786.16 | 100 |

### 3. Backcoating of the Fabric

The back-coating described in Table 2 and produced above was applied to a polyester/acrylic fabric having a fabric weight of 587 g/m². The back-coating was applied to the fabric by a Mathis labcoater type LTE-S, a “knife” coating machine. The fabric sample (33×43 cm) was fixed to the pin frame of the Mathis labcoater, and a knife was placed at the beginning of the fabric and the back-coating put close to the knife, which. moves forward and coats the fabric. The coating speed and the coating thickness can be adjusted to obtain the desired amount of coating on the fabric. When the fabric is coated the pin frame automatically goes into an oven, and the time in the oven and temperature of the oven can be adjusted. In this example, the coated fabric was dried 5 min at 90° C. and 10 min at 140° C.

The percentage of back-coating (also called add on) and bromine content of the back-coated fabric were determined by using with the following formulas:

1) [[[(Weight of the coated fabric)/(L(cm)*W(cm) of the fabric)]*10000]−(weight of the uncoated fabric(g/m²)]=back-coating weight(g/m²)
2) [(back-coating weight(g/m²)}/(weight of the uncoated fabric(g/m²))]*100=% of the back-coating on the fabric

The percentage of Bromine on the fabric is calculated with the following formula:

1) (% of the back-coating on the fabric)×(% FR dispersion in dry pphr in the back-coating)=% Brominated FR on the fabric
2) (% Brominated FR on the fabric)×(% bromine content in the FR)=% of Bromine on the fabric

Using the above formulas, it was determined that the back-coating of the fabric resulted in 42.8% back-coating on the fabric, and 17% of Bromine on the fabric.

After the application of the back-coating to the fabric, the back-coated fabric was subjected to the BS5852 (part one) and BS5852 (part two) flame retardancy tests along with the BS5651 water soaking test. The back-coated fabric readily passed these tests.

1-25. (canceled)

26. A textile product having affixed thereto a flame retarding amount of a N-2,3-Dibromopropyl-4,5-dibromohexahydrophthalimide.

27. The textile product according to claim 26 wherein said textile product is selected from fabrics, cloths, carpets, and the like made from synthetic and/or natural fibers.

28. The textile product according to claim 26 wherein said textile product is selected from natural and/or synthetic carpets; fabrics and/or cloths made from synthetic fibers; fabrics and/or cloths made from natural fibers; and fabrics and/or cloths made from blends of synthetic fibers and natural fibers.

29. The textile product according to claim 26 wherein said flame retarding amount of N-2,3-Dibromopropyl-4,5-dibromohexahydrophthalimide is in the range of from about 5 to about 60 wt. % N-2,3-Dibromopropyl-4,5-dibromohexahydrophthalimide, based on the total weight of the textile product.

30. A textile product having a coating layer deposited thereon, said coating layer containing a flame retarding amount of N-2,3-Dibromopropyl-4,5-dibromohexahydrophthalimide.

31. The textile product according to claim 30 wherein said coating layer is deposited onto at least one surface of said textile product.

32. The textile product according to claim 30 wherein said coating layer is a back-coating.

33. The textile product according to claim 31 wherein said textile product is selected from natural and/or synthetic carpets; fabrics and/or cloths made from synthetic fibers; fabrics and/or cloths made from natural fibers; and fabrics and/or cloths made from blends of synthetic fibers and natural fibers.

34. The textile product according to claim 33 wherein said flame retarding amount of N-2,3-Dibromopropyl-4,5-dibromohexahydrophthalimide is in the range of from about 5 to about 60 wt. % N-2,3-Dibromopropyl-4,5-dibromohexahydrophthalimide, based on the total weight of the textile product.

35. The textile product according to claim 30 wherein said natural and/or synthetic carpets; fabrics and/or cloths made from synthetic fibers; fabrics and/or cloths made from natural fibers; and fabrics and/or cloths made from blends of synthetic fibers and natural fibers are made from flame retarded materials.

36. A textile product having reduced flame spread characteristics comprising a textile material and a coating applied to a surface of said textile material and forming a layer thereon, said coating comprising a flame retarding amount of N-2,3-Dibromopropyl-4,5-dibromohexahydrophthalimide.

37. The textile product according to claim 36 wherein said flame retarding amount of N-2,3-Dibromopropyl-4,5-dibromohexahydrophthalimide is in the range of from about 5 to about 60 wt. % N-2,3-Dibromopropyl-4,5-dibromohexahydrophthalimide, based on the total weight of the textile product.

38. A method of imparting flame retardancy to a textile comprising affixing to said textile or a portion of said textile a coating comprising a flame retarding amount of N-2,3-Dibromopropyl-4,5-dibromohexahydrophthalimide.

39. The method according to claim 38 wherein said textile is selected from fabrics, cloths, carpets, and the like made from synthetic and/or natural fibers.

40. The method according to claim 38 wherein said textile is selected from natural and/or synthetic carpets; fabrics and/or cloths made from synthetic fibers; fabrics and/or cloths made from natural fibers; and fabrics and/or cloths made from blends of synthetic fibers and natural fibers.

41. The method according to claim 38 wherein said flame retarding amount of N-2,3-Dibromopropyl-4,5-dibromohexahydrophthalimide is in the range of from about 5 to about 60 wt. % N-2,3-Dibromopropyl-4,5-dibromohexahydrophthalimide, based on the total weight of the textile product.

42. The method product according to claim 41 wherein said natural and/or synthetic carpets; fabrics and/or cloths made from synthetic fibers; fabrics and/or cloths made from natural fibers; and fabrics and/or cloths made from blends of synthetic fibers and natural fibers are made from flame retarded materials.

43. A textile product having affixed thereto a back-coating, said back-coating containing a flame retarding amount of a N-2,3-Dibromopropyl-4,5-dibromohexahydrophthalimide said textile product selected from fabrics, cloths, carpets, and the like made from synthetic and/or natural fibers.

44. The textile product according to claim 43 wherein said flame retarding amount of N-2,3-Dibromopropyl-4,5-dibromohexahydrophthalimide is in the range of from about 5 to about 60 wt. % N-2,3-Dibromopropyl-4,5-dibromohexahydrophthalimide, based on the total weight of the textile product.

45. The textile product according to claim 44 wherein said textile is selected from natural and/or synthetic carpets; fabrics and/or cloths made from synthetic fibers; fabrics and/or cloths made from natural fibers; and fabrics and/or cloths made from blends of synthetic fibers and natural fibers.

46. The textile product according to claim 45 wherein said natural and/or synthetic carpets; fabrics and/or cloths made from synthetic fibers; fabrics and/or cloths made from natural fibers; and fabrics and/or cloths made from blends of synthetic fibers and natural fibers are made from flame retarded materials.

47. A composition comprising i) N-2,3-Dibromopropyl-4,5-dibromohexahydrophthalimide; ii) one or more organic liquids, water, or mixtures thereof; iii) one or more polymers; and, optionally, iv) one or more other fire retardants, dyes, wrinkle resist agents, foaming agents, buffers, pH stabilizers, fixing agents, stain repellants such as fluorocarbons, stain blocking agents, soil repellants, wetting agents, softeners, water repellants, stain release agents, optical brighteners, emulsifiers, thickeners, and surfactants.

48. The composition according to claim 47 wherein said polymer is either a polymer latex or a polymer plastisol compound.

49. The composition according to claim 48 wherein ii) is water.

50. The composition according to claim 47 wherein said composition is suitable for use in providing flame retardancy to a textile.
